(19) United States
(12) Patent Application Publication
(10) Pub. No.: US 2011/0193954 A1
(43) Pub. Date: Aug. 11, 2011

(54) APPARATUS FOR THE MEASUREMENT OF THE TOPOGRAPHY AND PHOTOELECTRIC PROPERTIES OF TRANSPARENT SURFACES

(75) Inventor: Wojciech Jan Walecki, Sunrise, FL (US)

(73) Assignee: SUNRISE OPTICAL LLC, SUNRISE, FL (US)

(21) Appl. No.: 12/701,671

(22) Filed: Feb. 8, 2010

(51) Int. Cl. H04N 7/18

(52) U.S. Cl. 348/135; 348/207.1; 348/E07.085

(57) ABSTRACT

The apparatus for measurement of the topography of transparent surfaces is described. This is achieved by the observation and evaluation of patterns produced by optical beam emitted by projector, reflected from the measured surface, and projecting images on the screen. If the measured surface has photoelectric properties, then the same optical beam can be used to modulate the electrical currents and voltages measured in the measured material and produce spatially resolved data characterizing the photo-electric response of the sample.

### PATENT LITERATURE

U.S. Pat. No. 5,118,955 June 1992 Cheng, David
U.S. Pat. No. 5,251,010 October 1993 Maltby, Jr.; Robert E.
U.S. Pat. No. 7,345,698 March 2008 Abbot, Mark M. et al.
U.S. Pat. No. 7,532,333 May 2009 Haeusler, Gerd et al.

### OTHER PUBLICATIONS

Andraka et al., Rapid Reflective Facet Characterization Using Fringe Reflection Techniques, Proceedings of ES2009, Energy Sustainability 2009, Jul. 19-23, 2009, San Francisco Calif. USA ES2009-90163.
Knauer et al., Phase Measuring Deflectometry: a new approach to measure specular free-form surfaces, Optical Metrology in Production Engineering, Proc. SPIE 5457, pp. 366-376, April 2004, pp. 366-376.
Klette et. al., Height data from gradient fields, Proc. Machine Vision, Applications, Architectures and Systems Integration V, SPIE 2908, Boston Mass., Nov. 18-19, 1996, pp. 204-215.
Klette et al., Handbook of Computer Vision and Applications, Signal Processing and Pattern Recognition, Academic Press 1999, Volume 2 pp. 531-590 ISBN 0-12-379772-1
Ritter et al., Opt. Lasers Eng. 1, 33 (1983)

### BACKGROUND ART

The measurement of the flatness of large flat surfaces is of importance in many industries. Examples of such industries include steel manufacturing, automotive industry and many others.

### Interferometric Measurements

Measurement of the flatness of spectacularly reflective surfaces can be performed with great accuracy using interferometric techniques such phase shifting interferometry (PSI), and related techniques. The PSI interferometers provide excellent accuracy—in case of small samples (<8 inch) approaching and exceeding 0.1 nm.

For the large sample measurements the PSI instruments usually do employ the exit aperture optics of the size same or exceeding size of measured piece. In case of measurement of large flat surfaces of size measured by (diameter for round samples, or diagonal in case of common rectangular samples) of 1 m or larger require optics of the size larger than 1 m which becomes prohibitively expensive.

Other possible solution is use of several interferometric measurements performed over smaller sample portion and stitching these partial measurements in order to obtain the accurate measurements over larger sample area. Commercial tools employing such stitching process were developed in past twenty years. Great disadvantages of this method are slow speed and need for scanning. These tools while offering great accuracy for research or even limited quality control applications are too slow for most in line production applications.

Similar space limitations are suffered by Moire fringes techniques which usually require application of Moire grating having size similar to or larger than size of the measured sample.

### Measurement of the Surface Topography by Measurement of a Single Reflected Beam

Other approach which avoids excessive cost of the large optics required by interferometer are scanning systems employing a narrow beam of light approximating single ray of light to scan measured surface. By performing this single ray scan across the entire surface the information about local surface curvature is collected and shape of the surface is calculated. This approach was disclosed in U.S. Pat. No. 5,118,955 by David Cheng describing “A system for measuring the curvature of a surface includes a laser for emitting a beam of light to be incident upon the surface; a photodetector for detecting light reflected by the surface; a first stage for selectively moving the surface in a direction normal to the direction of the incident . . . ”. Similar system is also described by Robert E. Maltby in U.S. Pat. No. 5,251,010 titled “Optical roller wave gauge”.

### Measurement of the Topography of Surfaces by Observation and Analysis of the Distortion of the Images Reflected by Specularly Reflecting Surfaces

In their paper R. Ritter and R Hahn teach (R. Ritter and R. Hahn, Opt. Lasers Eng. 1, 33 (1983)) how one can extract information of topography of the specularly reflecting surfaces from images of the reflection of the grating in the specularly reflecting surface. The original configuration resembles closely arrangement presented in FIG. 1. The optical rays emanating from the grating are reflected by the measured specularly reflecting surface at almost normal angle. R. Ritter and R Hahn teach how to relate displacement of the observed pattern directly to normals of the surface.

In general these methods can lead to information on normal vector as a position on the measured surface. Several local and global mathematical methods allowing recovery of the actual shape were developed including global method described by Klette and Schlüns (Klette, R., Schlüns, K.: Height data from gradient fields, Proc. Machine Vision, Applications, Architectures and Systems Integration V, SPIE 2908, Boston, Mass., Nov. 18-19, 1996, pp. 204-215), and a variety of methods described in the recent review article by Klette (Reinhard Klette, Ryszard Kozera, and Karsten Schlüns, Handbook of Computer Vision and Applications, Signal Processing and Pattern Recognition, Academic Press 1999, Volume 2 p. 531-590 ISBN 0-12-379772-1).

Similar approach to measurement of the specularly reflecting surface is described by Mark Abbott and Eric Hegstrom in U.S. Pat. No. 7,345,698. In this case the distorted image of the line which reflection in the sheet glass is observed by cameras is used to find topography of the glass sheet moving on the conveyor belt.

The extension of these techniques is application of the phase shifted images. In this case as stated by Knauer et al. in their paper (M. Knauer, J. Kaminski, and G. Hausler, “Phase Measuring Deflectometry: a new approach to measure specular free-form surfaces”, Optical Metrology in Production Engineering, Proc. SPIE 5457, pp. 366-376, April 2004) “The basic principle is to project sinusoidal fringe patterns onto a screen located remotely from the surface under test and to observe the fringe patterns reflected via the surface. Any slope variations of the surface lead to distortions of the patterns. Using well-known phase-shift algorithms, we can precisely measure these distortions and thus calculate the surface normal in each pixel.” Gerd Haeusler, Markus Knauer, Ralf Lampalzer extended this idea further by application of several cameras as in U.S. Pat. No. 7,532,333 shown how to measure—even strongly curved—specular surfaces with an apparatus that measures a shape as well as local surface normals absolutely. This was achieved by the observation and evaluation of patterns that are reflected at the surface.

Similar approach was employed by Charles E. Andraka, Scott Sadlon, Brian Myer, Kirill Trapeznikov, Christina Liebner in their paper on metrology of the concentrators used in solar generators (Charles E. Andraka, Scott Sadlon, Brian Myer, Kirill Trapeznikov, Christina Liebner, “Rapid Reflective Facet Characterization Using Fringe Reflection Techniques”, Proceedings of ES2009, Energy Sustainability 2009, Jul. 19-23, 2009, San Francisco, Calif. USA ES2009-90163).

The method of measurement of the shape of specularly reflecting surface by means of the observation of known images reflected in this surface is very efficient in case of mirror like surfaces. In case of transparent surfaces where only weak Fresnel reflection is present this arrangement is quite difficult to implement. In particular camera 4 in FIG. 1 observing reflection in such surface will also observe objects located behind the measured surface 3 in FIG. 1 such as object 10 in FIG. 1. Even when phase shifting illumination of the diffusing screen 2 is employed motion of the object 10 affects results of the measurement.

### SUMMARY OF INVENTION

In this invention the specular surface is used to reflect radiation emitted from the projector towards the diffusing screen.

The relative sizes of the measured sample, screen and distances between sample and screen and relative positions of screen, the measured surfaces, camera, and projector are such that all rays are approximately normal to surface 3 and screen 2 in FIG. 3 and all approximation used in derivation of the Formula 23 in R. Ritter and R Hahn paper (R. Ritter and R. Hahn, Opt. Lasers Eng. 1, 33 (1983)) are valid.

Initially the system is calibrated using flat mirror placed in the position of the measured surface 3 in FIG. 2. The image projected on the screen 2 in FIG. 2 is recorded. After this step the flat mirror is replaced by measured surface 3. The image is subsequently recorded by the camera 4. The shift of the image feature recorded when projector 1 beam is reflected by the mirror and by the measured surface is used to calculate normals of the measured surface using standard ray optics methods. If the measured surface is substantially perpendicular to impinging and reflected radiation than the slope of the measured surface in any of directions in plane of the mirror is proportional to the displacement of the images in any of the directions measured in plane of the screen (which is parallel to the mirror) as shown by Ritter and Hahn.

The first advantage of the invention is that the proposed arrangement is immune to the presence of any diffusely scattering objects positioned behind measured surface such as object 10 in FIG. 2, since the light emanating from the object 10 does not form image on the screen 2 and is not strongly interfere with image formed on the screen 2.

The second advantage of the proposed invention is that measurement is relatively immune to the stray light impinging measured surface as long as this stray light is not reflected toward screen 2.

The third advantage of the invention is that it allows to perform measurement of photoelectric characteristics of the measured surface in the same apparatus. In this case the measured surface is connected to electric meter 6 which allows measurement of the photoelectric properties as a function of various illumination conditions determined by the images illuminating surface of the sample.

### BRIEF DESCRIPTION OF DRAWINGS

FIG. 1 represents the device for the measurement of the transparent surface in the first configuration (Prior Art).

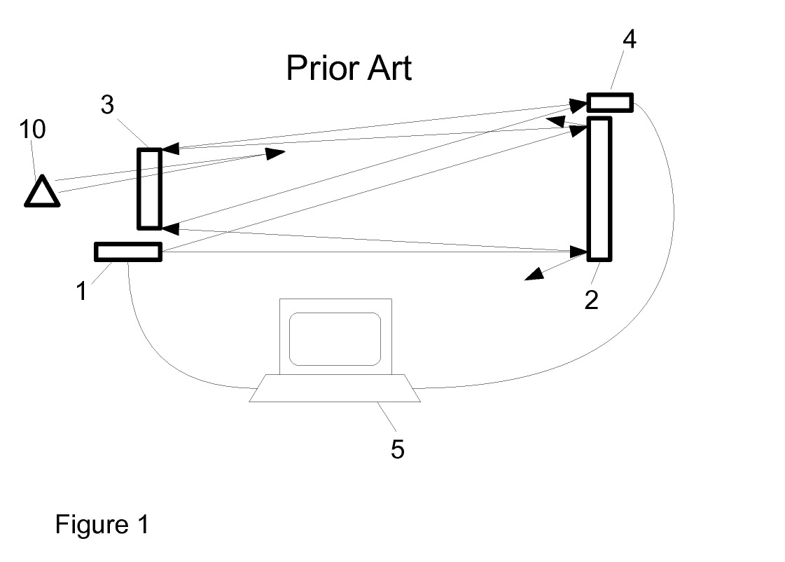

FIG. 2 represents the device for the measurement of the transparent surface in the second configuration.

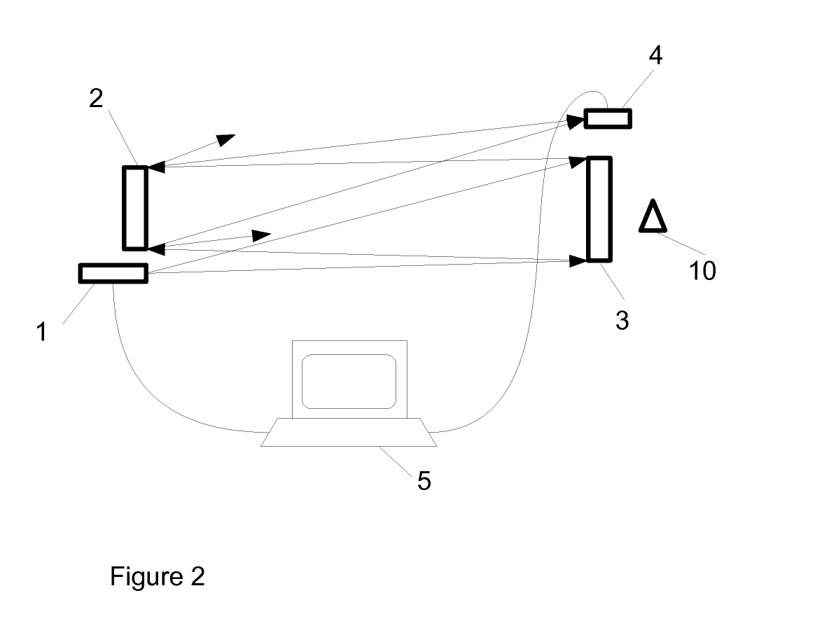

FIG. 3 represents the device for the measurement of the photoelectric and shape characteristics in the second configuration

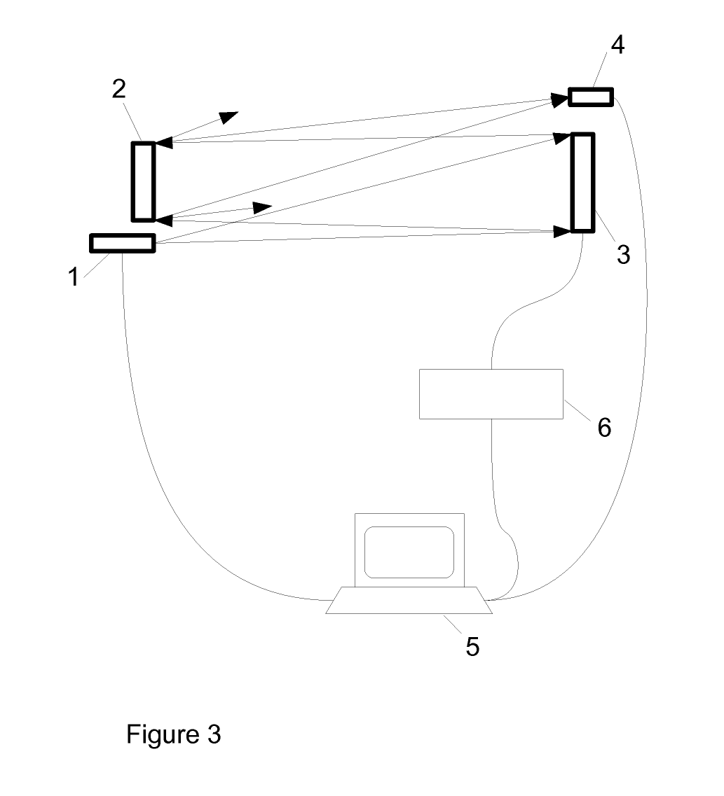

I claim:

1. System for measurement of the shape of a specularly reflective surfaces comprising a computer controlling the projector, the projector being in optical communication with the reflective surface and illuminating reflective surface with an set of intensity patterns, where the spectacularly reflective surface is reflecting optical beam toward a diffusing screen, and forms images on the diffusing screen, and the diffusing screen is in an optical communication a camera objective which is collecting radiation scattered by the diffusing screen, and camera detector which is optical communication with the camera detector collecting images projected on detector surface by camera objective, and analog to digital converter unit electrically connected to camera detector and connected to computer unit which is converting analog signal from the camera to digital signal transmitted to the computer, and computer unit which in addition to controlling projector is processing recorded images is calculating coordinates of the measured surfaces from the normals of the surface.

2. System for measurement of the photoelectric and geometrical characteristics of a specularly reflective surfaces comprising a computer connected to electrical meter, where the electrical meter is connected by means of electrical cables to measured specularly reflective surface, and the computer is connected and controlling the optical projector, the optical projector being in optical communication with the specularly reflective surface, and illuminating reflective surface with an set of intensity patterns, where the spectacularly reflective surface is reflecting optical beam toward a diffusing screen, and forms images on the diffusing screen, and the diffusing screen is in an optical communication a camera objective which is collecting radiation scattered by the diffusing screen, and camera detector which is optical communication with the camera detector collecting images projected on detector surface by camera objective, and analog to digital converter unit electrically connected to camera detector and connected to computer unit which is converting analog signal from the camera to digital signal transmitted to the computer, and computer unit which in addition to controlling projector is processing recorded images and according to phase shifting algorithm is calculating geometrical coordinates of the measured surfaces, and calculating space resolved opto-electrical properties of the measured surfaces.

3. A system as described in claim 2 where pattern comprises series of phase shifted images and calculating algorithm is a phase shifting algorithm.
